(19) United States
(12) Patent Application Publication
(10) Pub. No.: US 2012/0115996 A1
(43) Pub. Date: May 10, 2012

(54) FLAME PROTECTED POLYAMIDE MOLDING MATERIALS

(75) Inventor: Volker Butz, Neustadt/Weinstrasse (DE)

(73) Assignee: THOR GMBH, SPEYER (DE)

(21) Appl. No.: 13/261,051

(22) PCT Filed: Jun. 15, 2010
(86) PCT No.: PCT/EP2010/058344

§ 371 Date: Jan. 24, 2012

(30) Foreign Application Priority Data
Jun. 16, 2009 (EP) 09162767.9

(51) Int. Cl. C08K 5/5357

(52) U.S. Cl. 524/120

(57) ABSTRACT

The invention relates to thermoplastic polyamide molding materials having: (A) 10 to 99% by weight of at least one thermoplastic polyamide, (B) 1 to 40% by weight of a flame-protecting material of the formula (I), where A¹ and A² are independently, for example, a straight-chain or branched alkyl group having 1 to 4 carbon atoms, and (C) 0 to 70% by weight of further additives. The invention further relates to processes for producing such thermoplastic polyamide molding materials, and to the use of the molding materials.

The invention relates to thermoplastic polyamide molding materials having very good flame retardment properties, to processes for producing such thermoplastic polyamide molding materials, and to the use of the molding materials for producing fibers, films, and moldings of any kind.

Thermoplastic polyamides find diverse application in numerous fields of the art and of everyday life. This is mainly because of their good processing characteristics and the possibility of tailoring these thermoplastic polymers to the specific application.

A substantial part of the polyamides produced is currently accounted for by the standard grades PA6 (poly-ε-caprolactam) and PA66 (polyhexamethyleneadipamide). A smaller proportion is accounted for by PA11 (polyundecanamide), PA12 (poly-ε-laurolactam), PA610 (polyhexamethylenesebacamide), and PA612 (polyhexamethylenedodecanamide), and by copolyamides. A large part of the worldwide polyamide production is processed to fibers and fabrics; another part goes into technical applications, more particularly into automaking, the electrical industry, the packaging sector, mechanical engineering, and apparatus construction.

Though polyamides are self-extinguishing according to certain test methods, they nevertheless lose this property after the addition of fillers such as glass fibers or pigments. For numerous further applications, such as in electrical engineering and in automaking, for example, flame-retarded polyamide is nevertheless additionally required. In the event of fire, this flame retardment is intended to offer sufficient time to rescue people and valuables and to fight the fire.

Examples of flame retardants used include organic halogen compounds and red phosphorus. The halogen compounds are primarily chlorinated or brominated hydrocarbons, which are frequently combined in conjunction with zinc compounds or with antimony trioxide, which, although having a synergistic activity, is nevertheless classed as harmful. The halogen compounds have the disadvantage in the event of fire of releasing highly corrosive and toxic decomposition products, such as hydrogen chloride and hydrogen bromide, and of giving rise to substantial smoke.

Red phosphorus is mostly employed in an encapsulated form. In spite of the encapsulation, however, there is a risk of phosphorus fires at the high processing temperatures. As a result of disproportionation to form phosphines and phosphates, this may be accompanied by explosions and by increased wear of the processing machinery. Further disadvantages are the poor electrical corrosion characteristics of polyamides flame-retarded with red phosphorus, and the discoloration of these polyamides.

In order to minimize the disadvantages associated with halogen compounds and with red phosphorus, efforts have been underway for a number of years to develop flame-retarded polyamides without such flame retardants. In this vein, for example, the use of nitrogen compounds such as cyanoguanidine (DE 39 09 145 A1), melamine and melamine salts (DE 36 09 341 A1 and DE 41 41 861 A1) is proposed. Proposals have been made, furthermore, to carry out the polyamide synthesis in the presence of compounds which are incorporated into the polyamide chain during the polymerization. Thus, for example, for the polymerization of ε-caprolactam, the use of n-phosphonates and n-phosphates of ε-caprolactam has been recommended (in this regard see Journal of Applied Polymer Science, Vol. 47 (1993), pages 1185 to 1192).

It was an object of the invention, therefore, to provide halogen-free, readily processable thermoplastic polyamide molding materials which ensure effective flame retardment.

This object is achieved by means of thermoplastic polyamide molding materials comprising
(A) 10% to 99% by weight of at least one thermoplastic polyamide,
(B) 1% to 40% by weight of a flame retardant comprising one or more phosphonate compounds of the formula

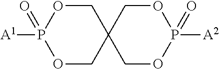

where A¹ and A² independently of one another represent a substituted or unsubstituted, straight-chain or branched alkyl group having 1 to 4 carbon atoms, substituted or unsubstituted benzyl, substituted or unsubstituted phenyl, or substituted or unsubstituted naphthyl, and
(C) 0% to 70% by weight of further additives, the sum of the percentage by weight of components (A) to (C) being 100.

In the context of the invention it has emerged, advantageously, that the phosphonate compound(s) (B) can be incorporated very effectively into the thermoplastic polyamide (A), allowing production not only of flame-retarded injection moldings but also of thin films and fine fibers. The flame retardant component used in accordance with the invention, the phosphonate compound(s) (B), is preferably in melted form at the customary incorporation temperature, defined below, and can be incorporated homogeneously into the thermoplastic polyamide (A).

The present invention additionally relates to the use of such thermoplastic polyamide molding materials for producing moldings, fibers, and films, and also to the moldings (of any kind) that are obtainable in the case of such use.

According to one preferred embodiment, the invention relates to fibers having a component (B) content in the range from 2% to 10% by weight, preferably in the range from 4% to 8% by weight, often also in the range from 6% to 7% by weight, based on the total weight of the fibers. The invention also relates, more particularly, to polyamide fibers, more particularly having a thickness in the range from 5 to 45 μm, preferably having a thickness of 10 to 20 μm.

As component (A), the thermoplastic polyamide molding materials of the invention contain 10% to 99% by weight, preferably 20% to 95% by weight, and frequently also 30% to 85% by weight of at least one polyamide.

The polyamides of the molding materials of the invention generally have a viscosity number of 70 to 350, preferably 70 to 170 ml/g, determined in a 0.5% strength by weight solution in 96% strength by weight sulfuric acid at 25° C. in accordance with the standard ISO 307.

Semicrystalline or amorphous polyamide resins having a molecular weight (weight-average) of at least 5000, of the kind described in, for example, the American patent specifications U.S. Pat. No. 2,071,250, U.S. Pat. No. 2,071,251, U.S. Pat. No. 2,130,523, U.S. Pat. No. 2,130,948, U.S. Pat. No. 2,241,322, U.S. Pat. No. 2,312,966, U.S. Pat. No. 2,512,606, and U.S. Pat. No. 3,393,210, are preferred.

Examples thereof are polyamides which derive from lactams having 7 to 13 ring members, such as polycaprolactam, polycaprylolactam and polylaurolactam, and also polyamides obtained by reacting dicarboxylic acids with diamines.

Dicarboxylic acids which may be employed are more particularly alkanedicarboxylic acids having 6 to 12, more particularly 6 to 10, carbon atoms, and aromatic dicarboxylic acids. Mention may be made here by way of example, as acids, of adipic acid, azelaic acid, sebacic acid, dodecanedioic acid, and terephthalic and/or isoterephthalic acid.

Suitable diamines are more particularly alkyldiamines having 6 to 12, more particularly 6 to 8, carbon atoms, and also n-xylylenediamine, di(4-aminophenyl)methane, di(4-aminocyclohexal)methane, 2,2-di(4-aminophenyl)propane, 2,2-di(4-aminocyclohexyl)propane or 1,5-diamino-2-methylpentane.

Polyamides used with preference are polyhexamethyleneadipamide, polyhexamethylenesebacamide, and polycaprolactam, and also copolyamides 6/66, more particularly having a caprolactam units fraction of 5% to 95% by weight. Additionally suitable polyamides are obtainable from ω-aminoalkyl nitriles such as, for example, aminocapronitrile (PA6) and adiponitrile, with hexamethylenediamine (PA66) by so-called direct polymerization in the presence of water, as described in DE 10 31 3681 A1, EP 1 198 491 A1. and EP 0 922 065 A1, for example.

Also suitable polyamides, furthermore, are those obtainable, for example, by condensation of 1,4-diaminobutane with adipic acid at elevated temperature (polyamide 4,6). Preparation processes for these compounds are described in EP 0 038 094 A1, EP 0 038 582 A1, and EP 0 039 524 A1, for example.

Suitable polyamides further include those obtainable by copolymerization of two or more of the preceding monomers, or mixtures of two or more polyamides, the mixing ratio being arbitrary.

Furthermore, partially aromatic copolyamides such as PA 6/6T and PA 66/6T have proven particularly advantageous with a triamine content of less than 0.5%, preferably less than 0.3% by weight (see EP 0 299 444 A1). The preferred partially aromatic polyamides with a low triamine content may be prepared by the process described in EP 0 129 194 A1 and EP 0 129 191 A1.

The nonexhaustive listing below maintains the stated and also further polyamides (A) in the sense of the invention, and the monomers comprised:
PA4 pyrrolidone; PA6 ω-caprolactam; PA7 ethanollactam; PA8 caprylolactam; PA9 9-aminopelargonic acid; PA11 11-aminoundecanoic acid; PA12 laurolactam;
PA46 tetramethylenediamine, adipic acid; PA66 hexa-methylenediamine, adipic acid; PA69 hexamethylenediamine, azelaic acid; PA610 hexamethylenediamine, sebacic acid; PA612 hexamethylenediamine, decanedicarboxylic acid; PA613 hexamethylenediamine, undecanedicarboxylic acid; PA1212 1,12-dodecanediamine, decanedicarboxylic acid; PA1313 1,13-diaminotridecane, undecanedicarboxylic acid; PA6T hexamethylenediamine, terephthalic acid; PA9T nonyldiamine/terephthalic acid; PAMXD6 n-xylylenediamine, adipic acid; PA6I hexamethylenediamine, isophthalic acid; PA6-3-T trimethylhexamethylenediamine, terephthalic acid; PA6/6T (see PA6 and PA6T); PA6/66 (see PA6 and 66); PA6/12 (see PA6 and PA12), PA66/6/610 (see PA66, PA6 and PA610); PA6I/6T (see PA6I and PA6T); PAPACM12 diaminodicyclohexylmethane, laurolactam; PA6I/6T/PACM like PA6I/6T +diaminodicyclohexylmethane; PA12/MACMI laurolactam, dimethyldiaminodicyclohexylmethane, isophthalic acid; PA12/MACMT laurolactam, dimethyldiaminodicyclohexylmethane, terephthalic acid; and PAPDA-T phenylenediamine, terephthalic acid.

The thermoplastic polyamide molding materials of the invention comprise as component (B) in accordance with the invention 1% to 40%, preferably 2% to 20%, and frequently also 4% to 10% by weight of a flame retardant comprising (often also consisting of):
(B) one or more phosphonate compounds of the formula

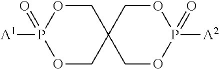

where A¹ and A² independently of one another represent a substituted or unsubstituted, straight-chain or branched alkyl group having 1 to 4 carbon atoms, substituted or unsubstituted benzyl, substituted or unsubstituted phenyl, substituted or unsubstituted naphthyl.

Preference is given to molding materials comprising as flame retardant component only one compound of the above formula.

“Alkyl group” denotes a saturated aliphatic hydrocarbon group, which may be straight-chain or branched and may have from 1 to 4 carbon atoms in the chain. Alkyl is preferably methyl, ethyl, 1-propyl, 2-propyl, 1-butyl, 2-butyl, 2-methyl-l-propyl(isobutyl), and 2-methyl-2-propyl (tert-butyl).

“Substituted” means that, for example, the alkyl group or phenyl group is substituted by one or more substituents selected from alkyl, aryl, aralkyl, alkoxy, nitro, carboalkoxy, cyano, halogen, alkylmercaptyl, trihaloalkyl or carboxyalkyl.

“Halogen” denotes chlorine (chloro), fluorine (fluoro), bromine (bromo) or iodine (iodo).

“Aryl” denotes an aromatic, cyclic group having 5 to 14 C atoms, as for example phenyl or naphthyl;

According to one preferred embodiment, the thermoplastic polyamide molding materials of the invention comprise as phosphonate compound (B) a compound of the formula below

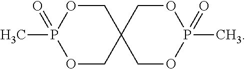

This compound, known under the names 2,4,8,10-tetraoxa-3,9-diphosphaspiro[5.5]undecane-3,9-dimethyl 3,9-dioxide, 3,9-dimethyl-2,4,8,10-tetraoxa-3,9-diphosphaspiro[5.5]undecane 3,9-dioxide, with the CAS number 3001-98-7, is available for example from THOR GmbH (Speyer, Germany, brand name AFLAMMIT™ TL1260).

According to one preferred embodiment, the thermoplastic polyamide molding materials of the invention comprise component(s) (B) as sole flame retardant(s). According to another preferred embodiment of the invention, the thermoplastic polyamide molding materials of the invention comprise the compound of the formula below

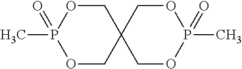

as sole flame retardant.

As components (C), the molding compounds of the invention may comprise generally 0% to 70%, preferably up to 50%, by weight of further additives.

As component (C), the molding materials of the invention may comprise 0% to 3%, preferably 0.05% to 3%, more preferably 0.1% to 1.5%, and more particularly 0.1% to 1% by weight of one (or more lubricants). Preference is given to aluminum salts, alkali metal salts or alkaline earth metal salts or esters or amides of fatty acids having 10 to 44 C atoms, preferably having 14 to 44 C atoms. The metal ions are preferably alkaline earth metal and Al, with Ca or Mg being particularly preferred. Preferred metal salts are Ca stearate and Ca montanate, also Al stearate. Mixtures of different salts can be used as well, with the mixing ratio being variable.

The carboxylic acids used may be 1- or 2-functional. Examples include pelargonic acid, palmitic acid, lauric acid, margaric acid, dodecanedioic acid, behenic acid, and preferably stearic acid, capric acid, and montanic acid (mixture of fatty acids having 30 to 40 C atoms).

The aliphatic alcohols used may be 1- to 4-functional. Examples of alcohols are n-butanol, n-octanol, stearyl alcohol, ethylene glycol, propylene glycol, neopentyl glycol, and pentaerythritol, with glycerol and pentaerythritol being preferred.

The aliphatic amines used may be 1- to 3-functional. Examples thereof are stearylamine, ethylenediamine, propylenediamine, hexamethylenediamine, and di(6-aminohexyl)amine, with ethylenediamine and hexamethylenediamine being particularly preferred. Preferred esters or amides are, correspondingly, glyceryl distearate, glyceryl tristearate, ethylenediamine distearate, glyceryl monopalmitate, glyceryl trilaurate, glyceryl monobehenate, and pentaerythrityl tetrastearate.

Use may also be made of mixtures of different esters or amides, or esters with amides in combination, the mixing ratio being variable.

As further components (C), the molding materials of the invention may comprise heat stabilizers or antioxidants or mixtures thereof, selected from the group of the copper compounds, sterically hindered phenols, sterically hindered, aliphatic amines and/or aromatic amines.

Copper compounds may be present in the PA molding materials of the invention at 0.05% to 3%, preferably 0.1% to 1.5%, and more particularly 0.1% to 1% by weight, preferably in the form of Cu(I) halide, more particularly in a mixture with an alkali metal halide, preferably potassium iodide, more particularly in a ratio of 1:4, or of a sterically hindered phenol or of an amine stabilizer or mixtures thereof. Salts of monovalent copper that are contemplated include preferably copper(I) acetate, copper(I) chloride, bromide, and iodide. They may be present in amounts of 5 to 500 ppm copper, preferably 10 to 250 ppm, based on polyamide.

The advantageous properties are maintained more particularly if the copper is present in molecular distribution in the polyamide. This is achieved, for example, by adding to the molding material a concentrate comprising polyamide, a salt of monovalent copper, and an alkali metal halide, in the form of a solid, homogeneous solution. One typical concentrate, for example, is composed of 79% to 95% by weight of polyamide and 21% to 5% by weight of a mixture of copper iodide or bromide and potassium iodide. The copper concentration of the solid homogeneous solution is preferably between 0.3% and 3%, more particularly between 0.5% and 2%, by weight, based on the total weight of the solution, and the molar ratio of copper(I) iodide to potassium iodide is often between 1 and 11.5, preferably between 1 and 5.

Suitable polyamides for the concentrate are, for example homopolyamides and copolyamides, more particularly polyamide 6 and polyamide 6.6.

Suitable sterically hindered phenols as further' component (C) include in principle all compounds having a phenolic structure and containing on the phenolic ring at least one sterically space-filling group. A sterically space-filling group is, for example, the tert-butyl group or the isopropyl group.

Examples of the compounds contemplated are preferably those of the following formula:

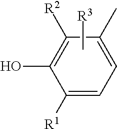

in which
R¹ and R² represent an alkyl group, a substituted alkyl group or a substituted triazole group, it being possible for the radicals R¹ and R² to be alike or different, and R³ represents an alkyl group, a substituted alkyl group, an alkoxy group or a substituted amino group.

Antioxidants of the type stated are described in DE-A 27 02 661 (U.S. Pat. No. 4,360,617), for example.

Another group of preferred sterically hindered phenols derive from substituted benzenecarboxylic acids, more particularly from substituted benzenepropionic acids.

Particularly preferred compounds from this class are compounds of the formula

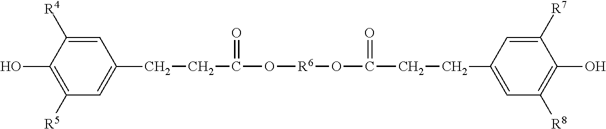

where R⁴, R⁵, R⁷, and R⁸ independently of one another represent C₁-C₈ alkyl groups which in turn may be substituted (at least one of them is a sterically bulky group), and R⁶ denotes a divalent aliphatic radical having 1 to 10 C atoms, which may also have C—O bonds in the main chain.

Preferred compounds conforming to this formula are

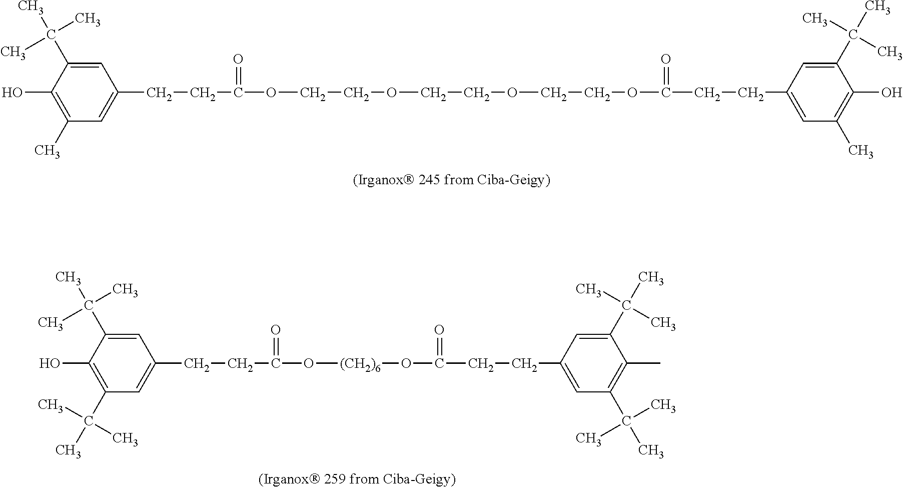

Sterically hindered phenols include by way of example the following:
2,2′-methylenebis(4-methyl-6-tert-butylphenol), 1,6-hexane-diol bis[3-(3,5-di-tert-butyl-4-hydroxyphenyl)propionate], pentaerythrityl tetrakis[3-(3,5-di-tert-butyl-4-hydroxy-phenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine.

Having proven particularly effective as component (C) are 2,2′-methylenebis(4-methyl-6-tert-butylphenyl), 1,6-hexanediol bis(3,5-di-tert-butyl-4-hydroxyphenyl]propionate (Irganox® 259), pentaerythrityl tetrakis[3-(3,5-di-tert-butyl-4-hydroxyphenyl)propionate], and also N,N′-hexamethylenebis-3,5-di-tert-butyl-4-hydroxyhydrocinnamide (Irganox® 1098) and the above-described Irganox® 245 (Ciba Geigy), which is especially suitable.

The phenolic antioxidants, which can be used individually or as mixtures in the molding materials, are present in an amount of 0.05% up to 3% by weight, preferably of 0.1% to 1.5% by weight, more particularly 0.1% to 1% by weight, based on the total weight of the molding materials (A) to (C).

In many cases, sterically hindered phenols having not more than one sterically space-filling group in ortho-position relative to the phenolic hydroxyl group have proven particularly advantageous, especially with regard to the assessment of the color stability on storage in diffuse light over prolonged time periods.

Fibrous or particulate fillers (C) include carbon fibers, glass fibers, glass beads, amorphous silica, calcium silicate, calcium metasilicate, magnesium carbonate, kaolin, chalk, powdered quartz, mica, barium sulfate, and feldspar, and they may be used in amounts of up to 40% by weight, more particularly 1% to 15% by weight, based on the sum of the percentages by weight of components (A) to (C). Preferred fibrous fillers include carbon fibers, aramid fibers, and potassium titanate fibers, with glass fibers in the form of E-glass being particularly preferred. They may be used as rovings or chopped glass in the commercially customary forms. For improved compatibility with the thermoplastic, the fibrous fillers may have been superficially pretreated with a silane compound.

Suitable silane compounds are those of the general formula

(X—(CH₂)ₙ)ₖ—Si(O—CₘH₂ₘ₊₁)₄₋ₖ

in which the substituents have the following definition:
X NH₂—

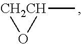

### HO—

n an integer from 2 to 10, preferably 3 and 4,
m an integer from 1 to 5, preferably 1 and 2,
k an integer from 1 to 3, preferably 1.

Silane compounds used with preference are aminopropyltrimethoxysilane, aminobutyltrimethoxysilane, aminopropyltriethoxysilane, aminobutyltriethoxysilane, and also the corresponding silanes containing a glycidyl group as substituent X. The silane compounds are used generally in amounts of 0.01% to 2%, preferably 0.025% to 1.0%, and more particularly 0.05% to 0.5% by weight (based on the fibrous fillers) for the surface coating.

Also suitable are acicular mineral fillers. Acicular mineral fillers for the purposes of the invention mean a mineral filler having a strongly pronounced acicular (needle-shaped) habit. An example is acicular wollastonite. The mineral preferably has an L/D (length to diameter) ratio of 8:1 to 35:1, more preferably of 8:1 to 11:1. The mineral filler may optionally have been pretreated with the silane compounds identified above; however, pretreatment is not an absolute necessity.

Further fillers include kaolin, calcined kaolin, wollastonite, talc, and chalk, and also platelet-shaped or needle-shaped nanofillers as well, preferably in amounts between 0.1% and 10%. For these purposes it is preferred to use boehmite, bentonite, montmorillonite, vermiculite, hectorite, and Laponite. In order to maintain effective compatibility between the platelet-shaped nanofillers and the organic binder, the platelet-shaped nanofillers are organically modified in accordance with the prior art. The addition of the platelet-shaped or needle-shaped nanofillers to the nanocomposites of the invention leads to a further increase in the mechanical strength.

Use is made more particularly of talc, which is a hydrated magnesium silicate of the composition Mg₃[(OH)₂/Si₄O₁₀] or 3 MgO-4SiO₂.H₂O. These so-called three-layer phyllosilicates have a triclinic, monoclinic or rhombic crystal structure with a platelet-shaped appearance. As further trace elements, Mn, Ti, Cr, Ni, Na, and K may be present, and the OH group may be partly replaced by fluoride.

Particular preference is given to using talc with particle sizes of 99.5%<20 μm. The particle size distribution is determined typically by sedimentation analysis, and is preferably as follows:

<20 μm 99.5% by weight

<10 μm 99% by weight

<5 μm 85% by weight

<3 μm 60% by weight

<2 μm 43% by weight

Products of this kind are available commercially in the form, for example, of Micro-Talc I.T. extra (from Omya).

Examples of impact modifiers as component (C) are rubbers which may contain functional groups. It is also possible to use mixtures of two or more different impact-modifying rubbers.

Rubbers which increase the toughness of the molding materials generally comprise an elastomeric fraction which has a glass transition temperature of less than −10° C., preferably of less than −30° C., and they comprise at least one functional group which is able to react with the polyamide. Examples of suitable functional groups include carboxyl, carboxylic anhydride, carboxylic ester, carboxamide, carboximide, amino, hydroxyl, epoxide, urethane or oxazoline groups, preferably carboxylic anhydride groups.

The preferred functionalized rubbers include functionalized polyolefin rubbers synthesized from the following components:
1. 40% to 99% by weight of at least one α-olefin having 2 to 8 C atoms,
2. 0% to 50% by weight of a diene,
3. 0% to 45% by weight of a C₁-C₁₂ alkyl ester of acrylic acid or methacrylic acid, or mixtures of such esters,
4. 0% to 40% by weight of an ethylenically unsaturated C₂-C₂₀ monocarboxylic or dicarboxylic acid or a functional derivative of such an acid,
5. 0% to 40% by weight of a monomer containing epoxy groups, and
6. 0% to 5% by weight of other radically polymerizable monomers,
   the sum of components 3) to 5) being at least 1% to 45% by weight, based on components 1) to 6).

Examples that may be given of suitable α-olefins include ethylene, propylene, 1-butylene, 1-pentylene, 1-hexylene, 1-heptylene, 1-octylene, 2-methylpropylene, 3-methyl-1-butylene, and 3-ethyl-1-butylene, with ethylene and propylene being preferred.

Suitable diene monomers include, for example, conjugated dienes having 4 to 8 C atoms, such as isoprene and butadiene, nonconjugated dienes having 5 to 25 C atoms, such as penta-1,4-diene, hexa-1,4-diene, hexa-1,5-diene, 2,5-dimethylhexa-1,5-diene, and octa-1,4-diene, cyclic dienes, such as cyclopentadiene, cyclohexadienes, cyclooctadienes, and dicyclopentadiene, and also alkenylnorbornene, such as 5-ethylidene-2-norbornene, 5-butylidene-2-norbornene, 2-methallyl-5-norbornene, 2-isopropenyl-5-norbornene, and tricyclodienes, such as 3-methyltricyclo[5.2.1.0.2.6]-3,8-decadiene, or mixtures thereof. Preference is given to hexa-1,5-diene, 5-ethylidenenorbornene, and dicyclopentadiene.

The amount of diene component is preferably 0.5% to 50%, more particularly 2% to 20%, and with particular preference 3% to 15%, by weight, based on the total weight of the olefin polymer. Examples of suitable esters are methyl, ethyl, propyl, n-butyl, isobutyl, and 2-ethylhexyl, octyl, and decyl acrylates, and the corresponding esters of methacrylic acid. Of these, methyl, ethyl, propyl, n-butyl, and 2-ethylhexyl acrylate and methacrylate are particularly. preferred. Instead of the esters or in addition to them it is also possible for the olefin polymers to contain acid-functional and/or latently acid-functional monomers of ethylenically unsaturated monocarboxylic or dicarboxylic acids.

Examples of ethylenically unsaturated monocarboxylic or dicarboxylic acids are acrylic acid, methacrylic acid, tertiary alkyl esters of these acids, more particularly tert-butyl acrylate and dicarboxylic acids, such as maleic acid and fumaric acid, or derivatives of these acids, and also monoesters thereof. Latently acid-functional monomers are understood to be those compounds which, under the polymerization conditions and/or on incorporation of the olefin polymers into the molding materials, form free acid groups. Examples thereof include anhydrides of dicarboxylic acids having 2 to 20 C atoms, more particularly maleic anhydride, and tertiary C₁-C₁₂ alkyl esters of the aforementioned acids, more particularly tert-butyl acrylate and tert-butyl methacrylate.

Examples of other monomers contemplated include vinyl esters and vinyl ethers.

Particularly preferred are olefin polymers formed from 50% to 98.9%, more particularly 60% to 94.85%, by weight of ethylene, and 1% to 50%, more particularly 5% to 40%, by weight of an ester of acrylic or methacrylic acid, 0.1% to 20.0%, more particularly 0.15% to 15%, by weight of glycidyl acrylate and/or glycidyl methacrylate, acrylic acid and/or maleic anhydride.

Particularly suitable functionalized rubbers are ethylene-methyl methacrylate-glycidyl methacrylate polymers, ethylene-methyl acrylate-glycidyl methacrylate polymers, ethylene-methyl acrylate-glycidyl acrylate polymers, and ethylene-methyl methacrylate-glycidyl acrylate polymers.

The polymers described above may be prepared by conventional processes, preferably by random copolymerization under high pressure (e.g., greater than 2 bar) and at elevated temperature.

The melt index of these copolymers is generally in the range from 1 to 80 g/10 min (measured at 190° C. under a load of 2.16 kg).

A further group of suitable rubbers include core-shell graft rubbers. These are graft rubbers, prepared in emulsion, which are composed of at least one “hard” and one “soft” constituent. A “hard constituent” is typically understood to be a polymer having a glass transition temperature of at least 25° C., while a “soft constituent” is typically understood to be a polymer having a glass transition temperature of not more than 0° C. These products have a structure comprising a core and at least one shell, the structure being dictated by the sequence of addition of the monomers. The soft constituents generally derive from butadiene, isoprene, alkyl acrylates, alkyl methacrylates or siloxanes, and optionally further comonomers. Suitable siloxane cores may be prepared starting, for example, from cyclic, oligomeric octamethyltetrasiloxane or tetravinyltetramethyltetrasiloxane. These may be reacted with, for example, γ-mercaptopropylmethyldimethoxysilane in a ring-open cationic polymerization, preferably in the presence of sulfonic acids, to form the soft siloxane cores. The siloxanes may also be crosslinked, for example by conducting the polymerization reaction in the presence of silanes having hydrolyzable groups such as halogen or alkoxy groups, such as tetraethoxysilane, methyltrimethoxysilane or phenyltrimethoxysilane. Examples of suitable comonomers here are styrene, acrylonitrile, and crosslinking or grafting-active monomers having more than one polymerizable double bond, such as diallyl phthalate, divinylbenzene, butanediol diacrylate or triallyl(iso)cyanurate.

The hard constituents generally derive from styrene, α-methylstyrene, and copolymers thereof, comonomers to be recited here including, preferably, acrylonitrile, methacrylonitrile, and methyl methacrylate.

Preferred core-shell graft rubbers comprise a soft core and a hard shell, or a hard core, a first soft shell, and at least one further hard shell. The incorporation of functional groups such as carbonyl, carboxyl, acid anhydride, acid amide, acid imide, carboxylic esters, amino, hydroxyl, epoxy, oxazoline, urethane, urea, lactam or halobenzyl groups takes place in this case preferably by the addition of suitably functionalized monomers in the polymerization of the last shell. Suitable functionalized monomers are, for example, maleic acid, maleic anhydride, monoesters or diesters or maleic acid, tertiary-butyl(meth)acrylate, acrylic acid, glycidyl(meth)acrylate, and vinyloxazoline. The fraction of monomers having functional groups is generally 0.1% to 25% by weight, preferably 0.25% to 15% by weight, based on the total weight of the core-shell graft rubber. The weight ratio of soft to hard constituents is generally 1:9 to 9:1, preferably 3:7 to 8:2.

Rubbers of this kind are known per se and described in EP-A 0 208 187, for example. Oxazine groups for functionalization can be incorporated in accordance with EP-A 0 791 606, for example.

Another group of suitable impact modifiers are thermoplastic polyester elastomers. By polyester elastomers here are meant segmented copolyether esters which comprise long-chain segments, deriving generally from poly(alkylene) ether glycols, and short-chain segments, deriving from low molecular mass diols and dicarboxylic acids. Products of this kind are known per se and described in the literature, as in U.S. Pat. No. 3,651,014, for example. Corresponding products are also available commercially under the names Hytrel™ (Du Pont), Arnitel™ (Akzo), and Pelprene™ (Toyobo Co. Ltd.). Mixtures of different rubbers can also be used.

As further component (C), the thermoplastic molding materials of the invention may comprise customary processing assistants such as stabilizers, antioxidants, further agents to counter thermal decomposition and decomposition by ultraviolet light, lubricants and mold release agents, colorants such as dyes and pigments, nucleating agents, plasticizers, flame retardants, etc.

Examples of antioxidants and heat stabilizers include phosphites and further amines (e.g., TAD), hydroquinones, various substituted representatives of these groups, and mixtures thereof, in concentrations of up to 1% by weight, based on the weight of the thermoplastic molding materials.

UV stabilizers, which are used generally in amounts of up to 2% by weight, based on the molding material, include various substituted resorcinols, salicylates, benzotriazoles, and benzophenones.

Colorants added may be inorganic pigments, such as titanium dioxide, ultramarine blue, iron oxide and carbon black and/or graphite, and also organic pigments, such as phthalocyanines, quinacridones, perylenes and also dyes, such as nigrosine and anthraquinones.

Nucleating agents used may be sodium phenylphosphinate, aluminum oxide, silicon dioxide, and, preferably, talc.

The thermoplastic molding materials of the invention may be prepared by conventional processes, by mixing the starting components in customary mixing equipment such as screw extruders, spinning extruders, kneaders, calenders, Brabender mills or Banbury mills, and then extruding the mixture. Mixing may also take place in the course of extrusion. Following extrusion, the extrudate can be cooled and comminuted. It is also possible for individual components to be premixed and then added to the rest of the starting materials individually and/or likewise in mixed form. The mixing temperatures are generally 200 to 300° C., preferably 230 to 280° C., more preferably 250 to 260° C.

According to a further preferred procedure, the component(s) (B) and also, optionally, (C) may be mixed with a prepolymer of the polyamide, converted, and pelletized. The pellets obtained are subsequently incorporated in solid phase, preferably under inert gas, continuously or discontinuously, into the component (A) that is to be made flame-retardant.

The thermoplastic molding materials of the invention are notable for good flame retardment properties and also for good processability/flowability and also thermal stability.

The molding materials are suitable for producing fibers, films, and moldings of any kind. A number of preferred examples are as follows: household articles, carpets, textiles, electronic components, medical devices, and automotive components.

The invention is illustrated in more detail by the examples below.

### EXAMPLES

The components used were as follows:

### Component (A):

Polyamide 6 having a viscosity number VN of 146 to 151 ml/g, measured as a 0.5% strength by weight solution in 96% strength by weight sulfuric acid at 25° C. in accordance with ISO 307 (Ultramid B27 from BASF SE was used).

### Component (B):

A phosphonate compound of the formula below, obtainable under the brand name AFLAMMIT™ TL1260 (Thor GmbH).

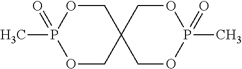

Components (A) and (B) were converted to pellets in a single-screw extruder at 255° C. These pellets were extruded at a melt temperature of 255° C. to form sample specimens.

The tests carried out were as follows:

Fire test by a method based on standard UL94, on test specimens with thicknesses of 0.8 mm and 1.6 mm and with a length of 200 mm and a width of 18 mm. The compositions of the test specimens and also the results of the fire test measurements, in duplicate determination, are given in the table below.

| | | | | Total | |
|---|---|---|---|---|---|
| | Component | Burn | Burn | afterburn | Burn |
| Sample | (B) | time 1 | time 2 | time | length |
| specimen | [% by weight] | (seconds) | (seconds) | (sec) × 5 | [mm] |
| Specimen 1 | 0 | 7 | 8 | 65 | 70 |
| 0.8 mm | | | | | |
| Specimen 1 | 0 | 3 | 5 | 40 | 30 |
| 1.6 mm | | | | | |
| Specimen 2 | 2 | 3 | 4 | 40 | 50 |
| 0.8 mm | | | | | |
| Specimen 2 | 2 | 3 | 3 | 35 | 20 |
| 1.6 mm | | | | | |
| Specimen 3 | 4 | 2 | 3 | 30 | 40 |
| 0.8 mm | | | | | |
| Specimen 3 | 4 | 1 | 3 | 25 | 20 |
| 1.6 mm | | | | | |
| Specimen 4 | 6 | 1 | 2 | 18 | 20 |
| 0.8 mm | | | | | |
| Specimen 4 | 6 | 1 | 2 | 12 | 10 |
| 1.6 mm | | | | | |
| Specimen 5 | 8 | 1 | 2 | 12 | 10 |
| 0.8 mm | | | | | |
| Specimen 5 | 8 | 1 | 1 | 10 | 10 |
| 1.6 mm | | | | | |

1. A thermoplastic polyamide molding material comprising
(A) 10% to 99% by weight of at least one thermoplastic polyamide,
(B) 1% to 40% by weight of a flame retardant comprising as sole flame retardant one or more phosphonate compounds of the formula 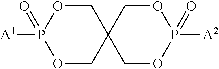
where A¹ and A² independently of one another represent a substituted or unsubstituted, straight-chain or branched alkyl group having 1 to 4 carbon atoms, substituted or unsubstituted benzyl, substituted or unsubstituted phenyl, or substituted or unsubstituted naphthyl, and
(C) 0% to 70% by weight of further additives, the sum of the percentage by weight of components (A) to (C) being 100.

2. The thermoplastic polyamide molding material as claimed in claim 1, comprising as phosphonate compound (B) a compound of the formula below

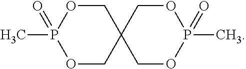

3. The thermoplastic polyamide molding material as claimed in claim 1, comprising as further additives (C) one or more compounds selected from pigments, dyes, plasticizers, antioxidants, phenolic antioxidants, and UV absorbers, and also mixtures thereof.

4. The thermoplastic polyamide molding material as claimed in claim 1, characterized in that it comprises as component (A) polyamide 66, polyamide 6, polyamide 612, polyamide 11 and/or polyamide 12.

5. The use of a thermoplastic polyamide molding material of claim 1 for producing fibers, films, and moldings.

6. A fiber, film or molding obtainable from the thermoplastic molding material of claim 1.

7. A process for producing a thermoplastic molding material of claim 1, the thermoplastic polyamide (A) being mixed with the flame retardant.

8. The process as claimed in claim 7, the thermoplastic polyamide (A) being mixed with the flame retardant in an extruder or kneader.

9. The process as claimed in claim 7, the thermoplastic polyamide (A) being mixed with the flame retardant at a temperature in the range from 200 to 300° C.
